(19) United States
(12) Patent Application Publication
(10) Pub. No.: US 2010/0074462 A1
(43) Pub. Date: Mar. 25, 2010

(54) Headset and Method of Using the Same

(76) Inventors: Sung Ho Lee, Gwanak-gu (KR); Se Hyun Lee, Ansan-si (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 11/913,309

(22) PCT Filed: May 4, 2007
(86) PCT No.: PCT/KR07/02214

§ 371 Date: Oct. 31, 2007

(30) Foreign Application Priority Data
Oct. 10, 2006 (KR) 10-2006-0098664

(51) Int. Cl. H04R 25/00

(52) U.S. Cl. 381/381

(57) ABSTRACT

A headset includes a main body, an earpiece formed on a side of the main body, a holder connecting part formed on another side of the main body, a coupling member that is coupled to the holder to support the holder on the holder connecting part, and an elastic member for pulling the holder toward the holder connecting part.

### TECHNICAL FIELD

The embodiment relates to a headset that is held over the ear so that the user can listen to sound output therefrom.

### BACKGROUND ART

With the development of the electronic and communications technology, mobile devices have been widespread. In addition, in order to fulfill the user's requirements, the functions of the mobile devices have been diversified while the size thereof has been gradually reduced.

Accordingly, a variety of peripheral devices that are used by being associated with the mobile devices have been released. For example, the peripheral devices include an attachable or built-in camera device, a smart card that is generally used as a sub-memory, and a headset that is held over the ear and performs a wireless communication with the mobile device through a wireless communication module to enable the user more conveniently use the mobile device.

The following will describe a headset having Bluetooth capability according to the related art. Mobile devices having the Bluetooth capability is equipped with, in addition to a main antenna module, an antenna module for the Bluetooth that operates in a 2.4 Ghz band. In addition, a Bluetooth module is mounted on a mainboard of the mobile device to perform a near field communication with the Bluetooth headset. The Bluetooth headset having the Bluetooth capability with the Bluetooth device is used as a hand-free device. However, since the Bluetooth headset does not require a cable, the handling convenience of the device can be improved and is easier to carry as compared with the conventional wire earphone for the hand-free set.

The Bluetooth headset of the related art includes a headset main body in which a variety of circuit devices including a Bluetooth module are installed and which is provided at a side with a microphone for receiving a sound signal from the user and an earpiece installed on a surface of the headset main body and provided at an extreme end with a speaker for outputting the sound signal. The earpiece is fitted in the ear. However, in the Bluetooth headset of the related art, since the earpiece is simply fitted in the ear, the headset is easily removed from the ear when the user moves excessively his/her body.

Further, since the ears have different shapes and sizes, the earpieces may not fit well when they are designed in an identical size and shape.

### DISCLOSURE

### Technical Problem

An embodiment provides a headset that can be stably held over the ear even when intensive outer force is applied thereto, e.g., even when the user does a violent exercise. Another embodiment provides a headset that is designed to fit well to the ear, thereby improving the wearing comfort.

### Technical Solution

The embodiment provides a headset comprising: a main body; an earpiece formed on a side of the main body; a holder connecting part formed on another side of the main body; a coupling member that is coupled to the holder to support the holder on the holder connecting part; and an elastic member for pulling the holder toward the holder connecting part.

The embodiment provides a headset comprising: a main body; an earpiece formed on a side of the main body; a holder formed on another side of the main body; and a hinge provided in a connecting part that connects the holder to the main body to allow the holder to rotate relative to the main body and provides a force for maintaining the holder at two or more rotational angles.

The embodiment provides a method of using a headset, comprising: inserting an earpiece into an ear, the earpiece protruding from a main body of the headset and outputting sound; and holding a holder on an auricle so that the main body can be securely supported on the ear, the holder being a separated part from the earpiece and protruding in an same direction as the earpiece.

### ADVANTAGEOUS EFFECTS

According to the above embodiments, since the headset is stably adhered to the ear, the headset can be stably held over the ear even when intensive outer force is applied thereto, e.g., even when the user does a violent exercise.

Furthermore, since the headset is designed to fit well to the ear, the wearing comfort can be improved.

It is to be understood that both the foregoing general description and the following detailed description of the present invention are exemplary and explanatory and are intended to provide further explanation of the invention as claimed.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a headset according to an embodiment;

FIG. 2 is an exploded perspective view of a headset according to an embodiment;

FIG. 3 is a bottom perspective view of a holder connecting part of a headset according to an embodiment;

FIG. 4 is a schematic side sectional view of a headset according to an embodiment;

FIG. 5 is an exploded perspective view of a headset according to another embodiment;

FIG. 6 is a bottom perspective view of a holder connecting part of a headset according to another embodiment; and

FIG. 7 is a schematic side sectional view illustrating an internal structure of a headset according to an embodiment.

### BEST MODE

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

### First Embodiment

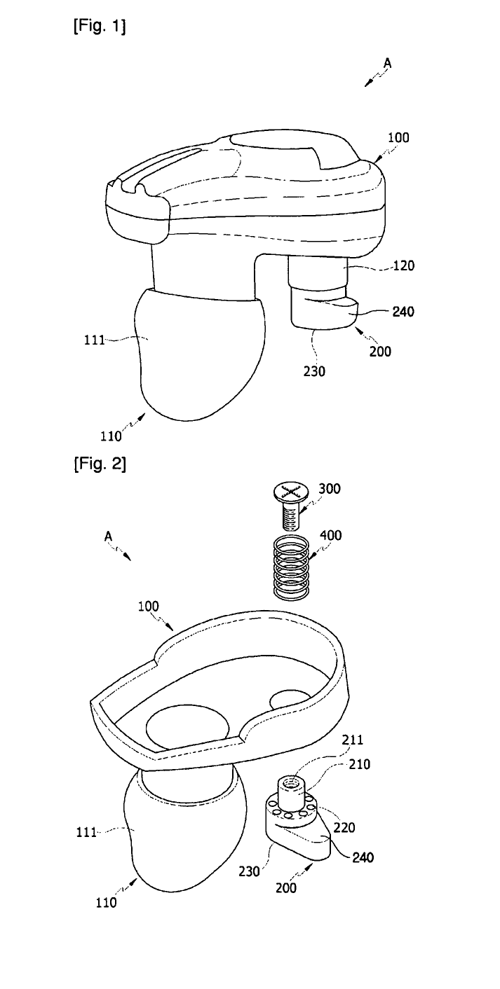

FIG. 1 is a perspective view of a headset according to an embodiment, FIG. 2 is an exploded perspective view of the headset of FIG. 1, and FIG. 4 is a schematic side sectional view of the headset of FIG. 1. Here, as FIG. 4 is a schematic sectional view, each of parts, which is represented by a identical hatching line, is illustrated as an integral part but this integral part may be formed with two or more different parts that are interconnected.

Referring to FIGS. 1, 2 and 4, a headset A of this embodiment includes a headset main body 100, an earpiece 110 that outputs sound and is fitted in the ear, more exactly, in an external auditory canal, a holder 200 rotatably coupled to the headset main body 100, and a coupling screw and spring 300 and 400 for connecting the holder 200 to the headset main body 100.

Although not shown in the drawings, a communication module such as a Bluetooth module, a control unit for amplifying signals transmitted to or from the Bluetooth module or modulating frequencies, a power supply unit for supplying electric power to the Bluetooth module and the control unit, and the like are installed in the headset main body 100. In addition, manipulation buttons for manipulating the operation of the headset A and a microphone are provided on an outer portion of the headset main body 100. The earpiece 110 is installed on a lower end of the headset main body 100 with reference to the drawings and the microphone is formed at a side far from the earpiece 110. With this structure, when the earpiece 110 is fixedly inserted in the ear, the microphone is oriented toward the user's mouth. In addition, a soft material member 111 formed of, for example, rubber is installed around an end of the earpiece 110 to enhance the frictional force by which the headset main body 100 is stably fixed in the ear.

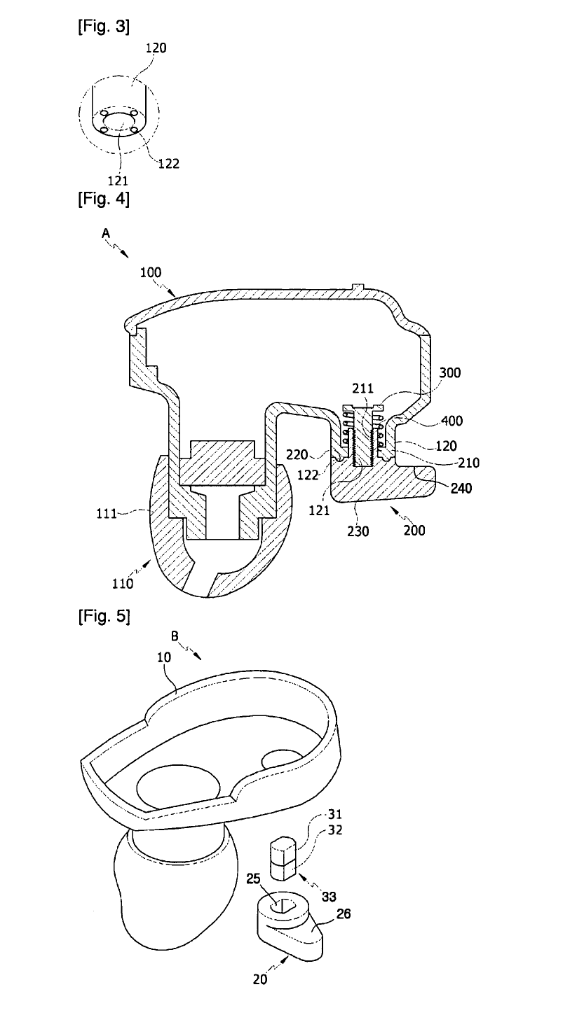

Further, a holder connecting part 120 is formed beside the earpiece on a surface where the earpiece 110 is provided. The holder connecting part 120 can be more clearly understood by a bottom perspective view of FIG. 3.

Referring to FIG. 3, the holder connecting part 120 protrudes downward from the headset main body 100 and is provided with a circular through hole 121. In addition, the holder connecting part 120 is provided at a surface facing the holder 200 with a plurality of fixing projections 122 spaced apart from each other by a uniform distance. In FIG. 4, although four fixing projections 122 are shown, the present invention is not limited to this. The number of the fixing projections 122 may be increased if required. The holder 200 is rotatably coupled to the holder connecting part 120 of the headset main body 100.

In more detail, the holder 200 is provided with an insertion part 210 corresponding to the through hole 121 of the holder connecting part 120. The insertion part 210 is provided at an inner surface with a female thread 211 that is screw-coupled with a coupling screw 300. The holder 20 is provided at a surface facing the holder connecting part 120 with a plurality of fixing groove 220 corresponding to the fixing projections 122. In FIG. 3, although eight fixing grooves 220 are shown, the present invention is not limited to this. The number of the fixing grooves 220 may vary depending on a rotational angle of the holder 220.

With this structure, the fixing projections 122 are engaged with the fixing grooves 220 at every 45° rotation of the holder 200 so that the stopped position of the holder 200 can be maintained. The reason for providing the plurality of the fixing projections is to securely maintain the stopped position of the holder 200. The reason for providing the plurality of the fixing grooves 220 is to set a rotational angle between the stopped positions. Needless to say, the forming locations of the fixing grooves 200 and the fixing projections 122 may be changed with each other. In addition, by varying the numbers of the fixing grooves 200 and the fixing projections 122, the snap feeling of the user may be improved.

A soft contact part 230 is provided on an outer surface of the holder 200. The contact part 230 may be completely formed of rubber or formed by coating a rubber material on a hard member. The soft contact part 230 allows the headset A to be securely fixed over the ear while preventing acute pain of the user. In the drawings, although the contact part 230 is fully formed of the rubber, the present invention is not limited to this. Here, the holder 200 is a major part for stably fixing the headset A over the ear. That is, by rotating the holder 200, the holder 200 is fitted on a specific portion of the user's auricle so that the position of the headset A is supported over the ear.

In order to fix the holder 200 on the users auricle, a hook part 240 is provided to extend from a lower portion of the contact part 230 in a predetermined direction. The extending direction of the hook part 240 is not parallel with a rotational axis of the holder 200 but inclined. Therefore, when the contact part 230 rotates, the hook part 240 is hooked on the auricle and thus the headset A is more securely supported over the ear. At this point, the hook part 240 may be hooked on a helix that is an outermost part of the auricle or on a concha defined in the helix.

Here, as the helix is the outermost part of the auricle, the hook part 240 is hooked on the helix and thus the earpiece 110 may be hooked in a portion defined between the tragus and antihelix. That is, the hook part 240 does not need to be deeply inserted in an external auditory canal. Furthermore, by the earpiece 110, there is no need for the headset A to be position-fixed by itself. Therefore, the overall size of the headset A can be reduced. In addition, the user's displeasure caused by the earpiece 110 hooked on the auricle can be reduced. Needless to say, when the earpiece 110 is configured to be deeply inserted in the external auditory canal, the headset A may be more securely fixed.

Further, the concha is a part positioned right above the external auditory canal defined inside the helix. Therefore, the headset can be securely fixed by the hook part 240 hooked on the concha. In this case, since the hook part 240 is not exposed to an external side, the product image can be improved.

In the foregoing description of the exemplary embodiment, the holder is hooked on the helix or the concha. However, the present invention is not limited to this configuration. That is, the hook part 240 may be hooked on other portions of the auricle so that the self-gravity of the headset can be supported. Needless to say, when the holder is hooked on the helix or the concha, the headset can be more securely fixed. However, as the hook part 240 rotates, the hook part is not in the way where the user wears the headset. After the headset is positioned at an accurate location, the hook part 240 further rotates so that the hook part 240 can be supported at the accurate position. The coupling screw 300 has a male thread corresponding to the female thread 211 formed on the holder 200 so that the holder 200 can be stably coupled to the headset main body 100. The spring 400 is interposed between the insertion part 210 of the holder 200 inserted into the holder connecting part 100 and the coupling screw 300 to pull the holder toward the headset main body 100. That is, the holder 200 closely contacts the holder connecting part 120 of the headset main body 100 by the elastic force of the spring 400.

Accordingly, the insertion part 210 of the holder 200 is inserted in the through hole 121 of the holder connecting part 120 and subsequently the spring 300 is installed in the insertion part 210. Next, the female thread 211 of the insertion part 210 is coupled to the coupling screw 300 while pressing the spring 300.

The following will describe the use of the headset structured as described above according to an embodiment. However, since an electronic operation using, for example, the Bluetooth module is similar to that of the related art, a description thereof will be omitted herein. Therefore, only a wearing method of the headset over the ear will be described hereinafter.

First, after the earpiece 110 is securely inserted in the external auditory canal of the ear, the user rotates the holder 20 by a desired angle so that the holder 200 can be hooked on the auricle and thus the headset A can be securely position over the ear. At this point, as described above, the hook part 240 is hooked on a specific portion of the auricle. Furthermore, it can be understood that, by varying the rotational angle of the holder 200 depending on the shape and size of the ear, the holder can be positioned on a more desired location.

Describing the rotating operation of the holder 200 in more detail, the holder 200 is fixed by the coupling screw 300 before the headset A is held over the ear. At this point, the fixing projections 122 and the fixing grooves 220 are engaged with each other by the elastic force of the spring 400 so as to limit the rotation of the holder 200. In this state, the user rotates the holder 200 in response to the auricle. At this point, the user pulls the holder 200 with a force greater than the elastic force of the spring 400 and, after the fixing projections 122 are disengaged with the fixing grooves 220, rotates the holder 200 to accurately adjust the location where the hook part 240 is hooked on the auricle. Subsequently, since the fixing projections 122 are engaged with the fixing grooves 220, the rotated portion of the holder 200 can be securely maintained.

Further, in order to remove the headset A from the ear, the process is performed in an opposite order to the above-described process.

The above-described using method of the present invention is different from that of the prior art headset having an oval-shaped support that is held over the auricle so that the headset main body can be disposed on a predetermined location but the earpiece is positioned at different locations according to the users. That is, since the users have ears that have different shapes and sizes, the earpiece cannot be aligned with the accurate location even when the support is hooked on the auricle. However, according to the using method of the present invention, since the holder can be position at a proper location depending on the shape and size of the ear after the earpiece is accurately inserted in the ear, the earpiece can be positioned at the right location of the external auditory canal regardless of the shape and size of the ear. Furthermore, the headset can be securely fixed over the ear in a state where the headset is positioned at the accurate location by the holder.

Meanwhile, in the above description, the insertion part, spring, and coupling screw, which enable the rotation of the holder and the holder connection part, may be referred to as a hinge assembly that induces the operational characteristic for rotating the holder relative to the holder connecting part.

### Second Embodiment

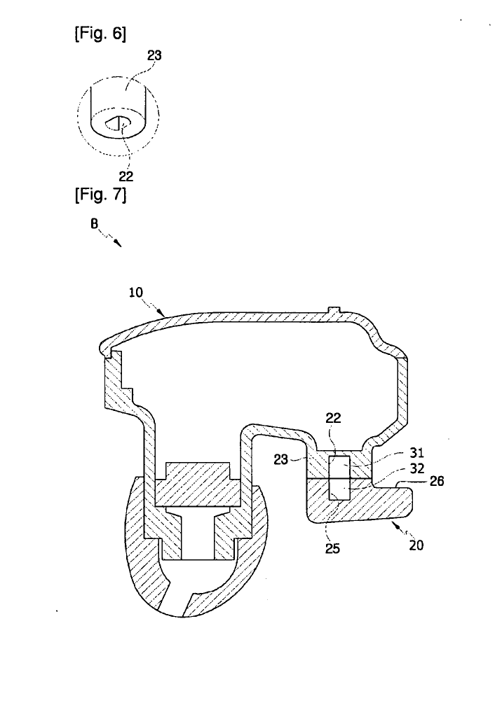

FIG. 5 is an exploded perspective view of a headset according to another embodiment of the present invention, FIG. 6 is a bottom perspective view of a holder connecting part of the headset of FIG. 5, and FIG. 7 is a schematic side sectional view illustrating an internal structure of the headset of FIG. 5.

Constituent parts of a headset B of this second embodiment, which are identical to those of the headset A of the first embodiment, will not be described.

Referring to FIGS. 5 through 7, a headset B of this second embodiment includes a headset main body 10, a holder connecting part 23 provided with a first hinge groove 22, and a holder 20 provided with a second hinge groove 25 corresponding to the first hinge groove 22, and a hinge 33 inserted in the first and second hinge grooves 22 and 25.

The hinge 33 includes a main body part 31 that is shaped to be inserted into the first hinge groove 22 and a holder part 32 that is shaped to be inserted in the second hinge groove 25 of the holder 20. The main body part 31 and the holder part 32 are designed to rotate about a common axis relative to each other. For example, the hinge 33 may be a click type hinge that rotates within a predetermined range and is fixed at the rotated angle, or a free-stop hinge that set at a variety of angles in accordance with the user's selection.

The click type hinge and the free-stop hinge are configured such that the main body part and the holder part rotate relative to each other in a state where a cam controlling a rotational angle and a spring applying an elastic force to a predetermined rotational angle of the cap. Since such click type and free-stop hinges have been widely used and developed for mobile phones, a detailed description thereof will be omitted herein. Further, by varying a cam profile applied to the hinge, an angle at which the hinge is fixed can be variously adjusted.

After the hinge 33 is inserted in the first and second hinge grooves 22 and 25, the earpiece is aligned in the external auditory canal. Subsequently, the holder 20 rotates to meet with the auricle (i.e., helix or concha of the auricle) and the holder 20 is fixed at a predetermined angle. Then, the hook part 26 is hooked on a specific location of the auricle to securely fix the position of the headset.

It will be apparent to those skilled in the art that various modifications and variations can be made in the present invention. Thus, it is intended that the present invention covers the modifications and variations of this invention provided they come within the scope of the appended claims and their equivalents.

### Mode for Invention

In the above-described embodiments, although a Bluetooth headset having a Bluetooth module is described, the present invention is not limited to this case. That is, the present invention may be applied to other wireless headsets to which other wireless communication standard is applied. Furthermore, the present invention can be applied to the wire headset.

Furthermore, the constituent parts each integrally represented by hatching in the drawings may be formed by combining two or more different parts. This will come within the scope of the present invention.

Furthermore, in the drawings, although the hook part extends in a direction perpendicular to the rotational axis of the holder, the present invention is not limited to this configuration. That is, the hook position of the hook part with respect to a specific location of the auricle during the rotation of the holder can be varied just when the hook part extends in an inclined direction with respect to the rotational axis of the holder. That is, the hook part may be provided just to be inclined with respect to the rotational axis to the holder.

### INDUSTRIAL APPLICABILITY

According to the headset of the embodiments, the hook part can be positioned at a proper location by rotating the holder regardless of the shape and size of the ear. Therefore, even when the headset is designed in a single size and shape, it can be stable held over the ear while improving the wearing comfort.

Furthermore, the headset is securely held over the ear by holder as well as the fixing operation of the earpiece even when intensive outer force is applied thereto, e.g., even when the user do a violent exercise.

1. A headset comprising:
a main body;
an earpiece on a side of the main body;
a holder connecting part spaced apart from the earpiece on the main body;
a holder;
a coupling member coupled to the holder to support the holder on the holder connecting part; and
an elastic member for exerting a force on the holder toward the holder connecting part.

2. The headset according claim 1, wherein at least a part of the holder functions as a rotational shaft that is rotatably inserted in the holder connecting part.

3. The headset according to claim 1, wherein the elastic member is interposed between the coupling member and the holder connecting part.

4. The headset according to claim 1, wherein the holder and the holder connecting part are provided at contacting surfaces with corresponding fixing grooves and fixing projections to fix the holder at a right location during the rotation of the holder.

5. The headset according to claim 1, wherein the holder comprises a contact part formed of a soft material, wherein the contact part is provided at an outer surface of the holder.

6. The headset according to claim 1, wherein the earpiece is capable of being inserted in a gap defined between a tragus and an antihelix of an ear or inserted into an external auditory canal.

7. The headset according to claim 1, wherein the holder comprises a hook part extending in a direction that is not parallel with a rotational axis of the holder.

8. The headset according to claim 1, wherein the earpiece comprises a soft member formed of a soft material, wherein the soft member is provided at an edge of the earpiece.

9. The headset according to claim 1, further comprising at least one component selected from the group consisting of a mobile communication module, a speaker, and a microphone, wherein the at least one component is installed in the main body.

10. The headset according to claim 1, wherein sound is output through the earpiece.

11. A headset comprising:
a main body;
an earpiece on a side of the main body;
a holder spaced apart from the earpiece on the main body; and
a hinge provided in a connecting part that connects the holder to the main body, wherein the hinge allows the holder to rotate relative to the main body and provides a force for maintaining the holder at two or more rotational angles.

12. The headset according to claim 11, wherein the earpiece comprises a soft member formed of a soft material, wherein the soft member is provided at an edge of the earpiece.

13. The headset according to claim 11, wherein the holder comprises a contact part formed of a soft material, wherein the contact part is provided at a portion of an outer surface of the holder.

14. The headset according to claim 11, further comprising at least one component selected from the group consisting of a mobile communication module, a speaker, and a microphone, wherein the at least one component is installed in the main body.

15. The headset according to claim 14, wherein the mobile communication module is a Bluetooth communication module.

16. The headset according to claim 11, wherein the hinge is a click type hinge or a free-stop hinge.

17. The headset according to claim 11, wherein the earpiece and the holder are formed on a surface of the main body, which is oriented toward an ear.

18. The headset according to claim 11, wherein the holder is capable of being held on a helix or a tragus of an auricle.

19. The headset according to claim 11, wherein the holder is provided with a hook part extending in a direction that is not parallel with a rotational axis of the holder.

20. The headset according to claim 11, wherein the earpiece is capable of being inserted in a portion of an ear defined between a tragus and a antihelix or inserted into an external auditory canal.

21. A method of using a headset, comprising:
inserting an earpiece into an ear, the earpiece protruding from a main body of the headset and capable of outputting sound; and
holding a holder on a portion of an auricle so that the main body can be securely supported on the ear, the holder being separated apart from the earpiece on the main body and protruding in a same direction as the earpiece.

22. The method according to claim 21, wherein the portion of the auricle, on which the holder is held, is a helix or a concha.
